(19) United States
(12) Patent Application Publication
(10) Pub. No.: US 2026/0326140 A1
(43) Pub. Date: Oct. 22, 2026

(54) SPINDLE METERING PUMP AND ASSOCIATED OPERATING METHOD

(71) Applicant: Dürr Systems AG, Bietigheim-Bissingen (DE)

(72) Inventors: Hannes Mayer, Ludwigsburg (DE); Daniel Nissan, Bönnigheim (DE); Marcin Zasada, Brackenheim (DE); Ing. Lothar Rademacher, Bietigheim-Bissingen (DE); Herbert Martin, Weinstadt (DE)

(21) Appl. No.: 19/122,047

(22) PCT Filed: Nov. 2, 2023
(86) PCT No.: PCT/EP2023/080560

§ 371 Date: Apr. 17, 2025

(30) Foreign Application Priority Data
Nov. 24, 2022 (DE) 10 2022 131 167.8

(51) Int. Cl. B05C 5/02; F04C 2/107; F04C 11/00; F04C 13/00; F04C 14/28

(52) U.S. Cl. CPC B05C 5/0225; F04C 2/107; F04C 11/005; F04C 13/00; F04C 14/28

(57) ABSTRACT

A spindle metering pump with a material inlet for receiving the application agent to be applied, a material outlet for dispensing the application agent to be applied and a rotary drive for rotating the spindle metering pump. The material outlet on the spindle metering pump is arranged further away from the rotary drive than the material inlet, so that an applicator can be flange-mounted directly on the spindle metering pump.

### CROSS-REFERENCE TO RELATED APPLICATIONS

This application is a national stage of, and claims priority to, Patent Cooperation Treaty Application No. PCT/EP2023/080560, filed on Nov. 2, 2023, which application claims priority to German Application No. DE 10 2022 131 167.8, filed on Nov. 24, 2022, which applications are hereby incorporated herein by reference in their entireties.

### TECHNICAL FIELD

The disclosed technology relates to a spindle metering pump (e.g. screw spindle pump) for metering an application agent (e.g. adhesive, insulating material, sealant, PVC plastisol) onto a component (e.g. motor vehicle body component).

### BACKGROUND

Various types of metering devices are used in the prior art for metering highly viscous application agents (e.g. adhesives, insulating materials, sealants, PVC plastisols), such as piston metering devices (single or double metering devices), gear metering pumps or spindle metering pumps, which can be designed as screw spindle pumps, for example, as is known from EP 2 961 988 B1. Screw spindle pumps offer the advantage over piston metering pumps that endless metering is possible, i.e. in contrast to a piston metering pump, it is not necessary to interrupt the metering process in order to refill the piston metering pump. In practice, spindle metering pumps have therefore proven to be the best choice for metering highly viscous application agents.

With regard to the technical background of the disclosure, reference should also be made to DE 10 2019 112 792 A1, DE 10 2007 053 073 A1, EP 3 450 024 A1 and DE 10 2005 044 796 A1.

### BRIEF DESCRIPTION OF THE DRAWINGS

FIG. 1A shows a perspective view of a conventional spindle metering pump according to the state of the art.

FIG. 1B shows a perspective view of an application robot with the conventional spindle metering pump shown in FIG. 1A.

FIG. 2A shows a perspective view of a spindle metering pump according to the disclosed technology.

FIG. 2B shows a perspective view of an application robot with the spindle metering pump according to the disclosure mounted on it.

FIG. 3 shows a perspective view of the spindle metering pump according to the disclosure without the other components mounted on it.

FIG. 4 shows a schematic representation of an application device according to the disclosure with the spindle metering pump according to the disclosure, an upstream material pressure regulator and a piston pump.

FIG. 5 shows a flow diagram to illustrate the determination of the pump slip according to a first variant of the disclosure.

FIG. 6 shows a flow diagram to illustrate the determination of the pump slip according to a second variant of the disclosure.

FIG. 7 shows a perspective view to illustrate the application of an adhesive bead with a variable volume flow of adhesive.

### DETAILED DESCRIPTION

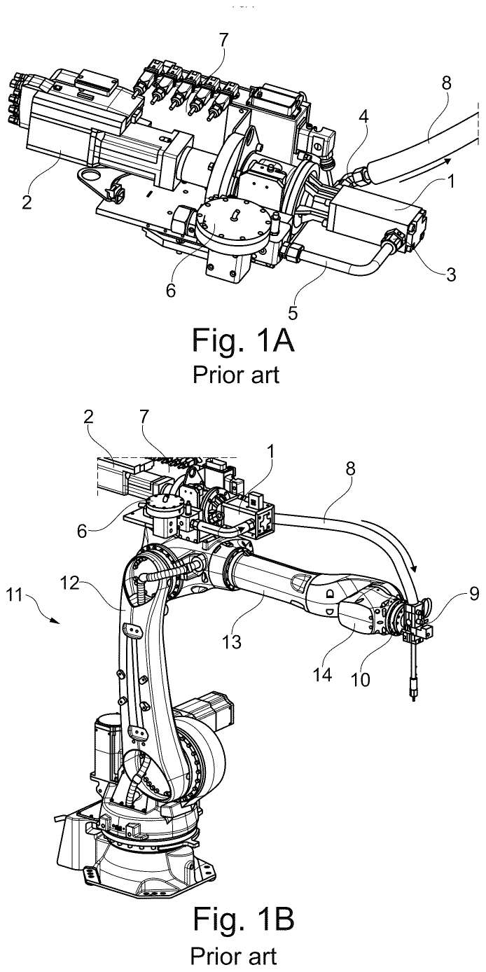

FIGS. 1A and 1B described below show a conventional application device with a spindle metering pump 1 for metering a highly viscous application agent, such as an adhesive, insulating material or sealant. The spindle metering pump 1 is driven by a servo drive 2, so that the rotational position of the spindle metering pump 1 is known from the control of the servo drive 2 and can therefore be used to control or regulate the spindle metering pump 1. The spindle metering pump 1 takes in the application agent to be conveyed via a material inlet 3 and then discharges the application agent to be conveyed via a material outlet 4. The material inlet 3 of the spindle metering pump 1 is connected via a pipe 4 to a material pressure regulator 6, which regulates the pump inlet pressure at the material inlet 3 of the spindle metering pump 1 to a predetermined target value. In addition, the spindle metering pump 1 has a flange-mounted heating module 7 to heat the application agent. The material outlet 4 of the spindle metering pump 1 is connected via a hose line 8 to an applicator 9, which is mounted on a mounting flange 10 of an application robot 11. The application robot 11 has two pivoting robot arms 12, 13 and a robot hand axis 14, as is well known from the prior art. The spindle metering pump 1 is attached to the distal robot arm 13 (“arm 2”), i.e. at a distance from the applicator 9 on the mounting flange 10 of the application robot 11. This structural separation of the applicator 9 on the one hand and the spindle metering pump 1 on the other is associated with various disadvantages, which are briefly described below.

A disadvantage of this known arrangement is the relatively long reaction times when the spindle metering pump 1 is switched on or generally when the volume flow of the application agent delivered by the spindle metering pump 1 changes. This leads to application errors, such as a so-called hammerhead or a so-called constriction, particularly when applying a sealant bead at the start of the bead.

Furthermore, due to the relatively long reaction times, it is hardly possible to dynamically change the conveyed volume flow during a so-called brush (e.g. during the application of a sealant bead).

In this context, it should also be mentioned that the hose line 8 between the material outlet 4 of the spindle metering pump 1 and the applicator 9 has an unavoidable hose breathing, so that a change in the volume flow delivered by the spindle metering pump 1 only arrives at the applicator 9 with a time delay.

The disclosed technology is therefore based on the task of creating a correspondingly improved spindle metering pump. The disclosure is based on the technical realization that the disturbing structural separation between the applicator on the one hand and the spindle metering pump on the other is inherent to the design of the known spindle metering pumps and can hardly be avoided. This is due to the fact that the material inlet of the spindle metering pump is located at the free end of the spindle metering pump and prevents direct mounting of the applicator there. In contrast, the material outlet of the spindle metering pump is located at the drive end of the spindle metering pump in the known spindle metering pumps, where it is also not possible to mount the applicator. In the known design of the spindle metering pump, a line (e.g. hose line) is therefore absolutely necessary between the material outlet of the spindle metering pump and the applicator, which leads to the disadvantages described above.

The disclosure therefore provides for a modified design of the spindle metering pump in which the spatial arrangement of the material inlet and the material outlet is virtually reversed. This means that the material outlet on the spindle metering pump is arranged further away from the rotary drive (e.g. servo drive) than the material inlet. This allows the applicator to be flanged directly to the spindle metering pump, which is associated with various advantages that will be described in more detail.

In an embodiment of the disclosed technology, the material outlet of the spindle metering pump is located in the third or quarter of the pump housing of the spindle metering pump facing away from the rotary drive. The material inlet of the spindle metering pump, on the other hand, can be located in the drive-side third or quarter of the pump housing of the spindle metering pump.

It should also be mentioned that the material inlet and/or the material outlet on the spindle metering pump can be located laterally with respect to the axis of rotation of the spindle metering pump, for example in the same side surface of the pump housing of the spindle metering pump. Alternatively, however, it is also possible for the material inlet and the material outlet to be arranged on opposite side surfaces of the spindle metering pump or on adjacent side surfaces of the spindle metering pump.

It should also be mentioned that the rotary drive (e.g. servo drive) of the spindle metering pump can be arranged coaxially to the spindle of the spindle metering pump. In the spindle metering pump according to the disclosure, the application agent therefore flows away from the rotary drive parallel to the axis of rotation of the spindle metering pump during operation. In contrast, in the known spindle metering pumps, the application agent flows parallel to the axis of rotation of the spindle metering pump towards the rotary drive.

It should also be mentioned that the term spindle metering pump used in the context of the disclosure is to be understood generally and includes all rotary pumps that have a rotatable rotor in order to pump the application agent from the material inlet to the material outlet. In some embodiments, however, the spindle metering pump is a screw spindle pump as known, for example, from EP 2 961 988 B1.

Furthermore, it should also be mentioned that the disclosure is not limited to the above-mentioned high-viscosity application agents with regard to the application agent to be applied. Rather, the disclosure is generally suitable for the application of liquid or pasty application agents. In some embodiments, however, the spindle metering pump is designed for the application of adhesives (e.g. epoxy, polyurethane (PUR), isocyanate, hot butyl), insulating materials or sealants, with PVC plastisols (PVC: polyvinyl chloride) in particular also being mentioned as a possible application agent.

Furthermore, it should also be noted that the disclosure enables the application of the application agent to any type of component. In some embodiments, however, it is envisaged that the application agent is applied to motor vehicle body components.

The disclosure also comprises not only the spindle metering pump described above as an individual component or as an individual assembly. Rather, the disclosure also claims protection for an application device with such a spindle metering pump and an applicator for applying the application agent, wherein the applicator is flange-mounted directly to the end of the spindle metering pump facing away from the rotary drive. This direct flange-mounting of the applicator to the spindle metering pump enables a very short flow path between the material outlet of the spindle metering pump on the one hand and the applicator on the other. For example, the flow path between the material outlet of the spindle metering pump and the applicator can be shorter than 1 m, 50 cm, 20 cm, 10 cm or 5 cm. This short flow path is advantageous because it enables a fast reaction time, i.e. the application device can change the conveyed volume flow of the application agent highly dynamically.

It should also be mentioned that the direct flange-mounting of the applicator to the spindle metering pump allows the flow path between the material outlet of the spindle metering pump and the applicator to be hose-free and pipeless. The advantage of not having a hose between the material outlet of the spindle metering pump and the applicator is that there is no more annoying hose breathing.

It should also be mentioned that a material pressure regulator can be connected upstream of the material inlet of the spindle metering pump, which regulates the pump inlet pressure of the application agent at the material inlet of the spindle metering pump, in particular depending on the volume flow rate of the application agent conveyed.

In some embodiments, the material pressure regulator receives a predetermined target value for the pump inlet pressure of the application agent at the material inlet of the spindle metering pump, whereby the material pressure regulator then regulates the pump inlet pressure to the predetermined target value.

The pump inlet pressure of the application agent at the material inlet of the spindle metering pump can be regulated in such a way that the pump slip of the spindle metering pump is minimized or at least reduced. Pump slip is defined here as the deviation between the volume flow actually delivered by the spindle metering pump on the one hand and the theoretical volume flow specified by a pump characteristic curve of the spindle metering pump depending on the speed on the other. Ideally, the delivered volume flow of the application agent should be independent of the pressure ratios at the inlet and outlet of the spindle metering pump. This corresponds to the ideal of a metering device, but cannot be fully realized in practice due to the unavoidable pump slip. However, controlling the pump inlet pressure of the spindle metering pump using the material pressure regulator can minimize pump slip. In addition, the pump inlet pressure of the application agent can also be regulated in such a way that the wear of the spindle metering pump is minimized.

It has already been mentioned above that the material pressure regulator can receive a target value and then regulate the pump inlet pressure to the target value. The material pressure regulator can have a target input to receive this target value. For example, the target input of the material pressure regulator can be supplied with the target value via a proportional valve, with the proportional valve operating pneumatically.

The metering volume flow-dependent target values for the pump inlet pressure can be determined in a calibration run, for example. This involves running the spindle metering pump with the material pressure regulator open at various volume flows and determining the resulting metering pressure. This forms the basis for setting the input pressure (i.e. the target value) of the spindle metering pump in subsequent production operation.

In some embodiments, the spindle metering pump has a first pressure sensor to measure the pump inlet pressure of the application agent at the material inlet of the spindle metering pump, wherein the first pressure sensor can be connected to the material pressure regulator in order to supply the pump inlet pressure to the material pressure regulator as an actual value.

Furthermore, the spindle metering pump can have a second pressure sensor in order to measure the pump outlet pressure of the application agent at the material outlet of the spindle metering pump, whereby the second pressure sensor can be connected to the material pressure regulator in order to supply the pump outlet pressure to the material pressure regulator as an actual value.

In addition, the spindle metering pump can have a third pressure sensor that measures the pressure of the application agent at the inlet of the material pressure regulator, whereby the third pressure sensor can be connected to the material pressure regulator in order to supply the material pressure regulator with the pressure of the application agent at the inlet of the material pressure regulator as an actual value.

Furthermore, a rotary encoder can be provided to measure the rotary position of the spindle metering pump. Alternatively, it is also possible for the rotary position of the spindle metering pump to be provided by a servo drive.

In some embodiments, the application device has an additional piston pump, which is arranged upstream of the material pressure regulator and conveys the application agent with a specific pump outlet pressure via the material pressure regulator to the spindle metering pump. The pump outlet pressure of the piston pump can be greater than the desired pump inlet pressure of the spindle metering pump, so that the material pressure regulator between the piston pump and the spindle metering pump then regulates the pump outlet pressure of the piston pump down to the desired pump inlet pressure of the spindle metering pump.

The connection between the piston pump and the material pressure regulator can be made in the conventional way by a rigid pipe, whereby this pipe can also have a relatively long line length of more than 2 m, 4 m, 6 m, 8 m, 10 m or even 12 m. Alternatively, however, it is also possible for the piston pump to be connected to the material pressure regulator via a flexible hose line or by a combination of a rigid pipe line and a flexible hose line. Here too, the total line length between the piston pump and the material pressure regulator can be greater than 2 m, 4 m, 6 m, 8 m, 10 m or even greater than 12 m.

In some embodiments, the piston pump is a compressed air driven scoop piston pump, but other pump types are also possible in principle. However, it should be mentioned that the piston pump has a relatively high maximum delivery pressure, which can be at least 10 bar, 50 bar, 100 bar, 200 bar or 350 bar. For example, the compressed air-driven scoop piston pump marketed by the applicant under the product name “EcoPump VPS™” can be used as a piston pump.

With regard to the applicator, it should be mentioned in general that the applicator does not contain a regulator, but only at least one main valve, which optionally releases or blocks the dispensing of material by the applicator. In some embodiments, this main valve is designed as a main needle valve. This means that the main needle valve has a displaceable valve needle which, depending on its valve position, either releases or blocks a valve seat.

In addition, the application device according to the disclosure can have a heater to heat the application agent. For example, such a heater can be designed as a trace heater in order to heat a hose or tube carrying the application agent.

The application device according to the disclosure can have a mounting flange in order to detachably mount the application device on a robot flange of an application robot. The application device can contain the spindle metering pump with the rotary drive, the applicator, the material pressure regulator, the proportional valve, any pressure sensors and/or the heater. The integration of these components in the application device enables a quick change of the complete application device with all components, which was not possible with the structural separation of the components in the prior art. The other components mentioned above (e.g. rotary drive, applicator, material pressure regulator, proportional valve, pressure sensors, heating) can be flange-mounted to the spindle metering pump, so that the spindle metering pump together with these components forms a uniform assembly that can be mounted on or removed from the application robot.

In general, it should be mentioned that the spindle metering pump can be designed to deliver a volume flow of at least 5cm³/s, 10 cm³/s, 20 cm³/s or 24 cm³/s.

Furthermore, it should generally be mentioned that the spindle metering pump has a sufficiently large operating range of the volume flow, which covers the volume flow range from 2 cm³/s to 24 cm³/s.

It has already been briefly mentioned above that the rotary drive of the spindle metering pump can be an electromotive servo drive. This offers the advantage that the rotary position of the servo drive and thus also the rotary position of the spindle metering pump is known by controlling the servo drive, so that a separate rotary encoder for determining the rotary position of the spindle metering pump can be dispensed with.

The application device according to the disclosure was described above as a single-component system, which is designed for application using a single component (1K). However, it is also possible within the scope of the disclosure for two such application devices to each convey one component of a two-component material (2K), in which case a mixer mixes the two components of the two-component material to form the application agent. The disclosure therefore also claims protection for a two-component system.

In addition, the disclosure also claims protection for a complete application robot with several robot arms, optionally a robot hand axis and a robot flange, wherein the application device according to the disclosure described above is mounted on the robot flange.

In addition, the disclosure also claims protection for an operating method for the above-described application device according to the disclosure. Here, it may be provided that the pump slip of the spindle metering pump is determined. To determine the pump slip of the spindle metering pump, the disclosure provides two variants of the disclosure, which are described below.

In a first variant of the disclosure, the following steps are carried out to determine the pump slip of the spindle metering pump:
Close the main valve of the applicator,
Build-up of a predetermined pre-pressure at the material outlet of the spindle metering pump by the spindle metering pump delivering the application agent against the closed main valve,
Measure the pump outlet pressure at the material outlet of the spindle metering pump using the second pressure sensor,
Switching off the spindle metering pump when the pump outlet pressure at the material outlet of the spindle metering pump reaches the specified inlet pressure,
Regulation of the pump inlet pressure at the material inlet of the spindle metering pump to a constant target value by the material pressure regulator,
Measuring the pressure drop over time at the material outlet of the spindle metering pump or at the applicator upstream of the main valve during a monitoring period after the spindle metering pump has been switched off by the second pressure sensor, and
Evaluation of the pressure drop over time during the monitoring period to determine the pump slip of the spindle metering pump.

In a second variant of the disclosure, on the other hand, the following steps are carried out to determine the pump slip of the spindle metering pump:
Close the main valve of the applicator,
Build-up of a predetermined pre-pressure at the material outlet of the spindle metering pump by the spindle metering pump conveying the application agent against the closed main valve,
Measure the pump outlet pressure at the material outlet of the spindle metering pump using the second pressure sensor,
Detecting the rotational position of the spindle metering pump when the pump outlet pressure at the material outlet of the spindle metering pump reaches the specified inlet pressure, in particular by
   Measuring the rotary position using the rotary encoder or by
   Querying the rotary position of the servo drive of the spindle metering pump,
Regulation of the pump inlet pressure of the spindle metering pump to a constant target value by the material pressure regulator,
Control of the pump outlet pressure at the material outlet of the spindle metering pump to the specified inlet pressure by controlling the rotary drive of the spindle metering pump,
measuring the change in the rotational position of the spindle metering pump over time during a monitoring period after the predetermined upstream pressure has been reached, the monitoring period comprising several minutes, in particular five minutes, and
Evaluation of the temporal change in the rotary position of the spindle metering pump during the monitoring period to determine the pump slip of the spindle metering pump.

Depending on the pump slip determined, a correction can be made in order to avoid metering errors. For example, a new pump characteristic curve can be measured for this purpose, which reflects the relationship between the pump speed of the spindle metering pump on the one hand and the delivered volume flow on the other. This pump characteristic curve can then be stored in a control system.

It has already been mentioned above that the disclosure enables a highly dynamic change in the volume flow of the applied application agent within a so-called “brush”. For example, the “brush” can form an elongated bead of the application agent, which is applied to a component (e.g. motor vehicle body component). For example, adhesives and sealants are applied to the respective components in the form of such beads. The disclosure allows the volume flow of the applied application agent to be varied along the elongated bead, i.e. within a “brush”. This makes it possible to optimize the application result, whereby the feed speed of the applicator can also be varied along the bead. In the context of the disclosure, this aspect of the disclosure is of its own importance worthy of protection independently of the aspect of the disclosure which provides for the determination of the pump slip.

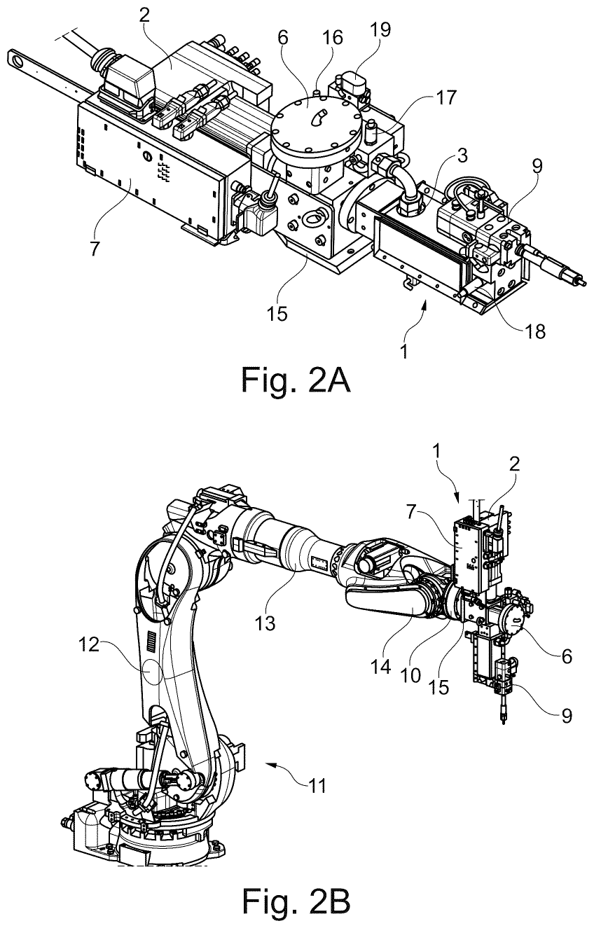

FIGS. 2A and 2B are now described below, which correspond in part to the prior art according to FIGS. 1A and 1B, so that reference is made to the above description in order to avoid repetition, the same reference signs being used for corresponding details.

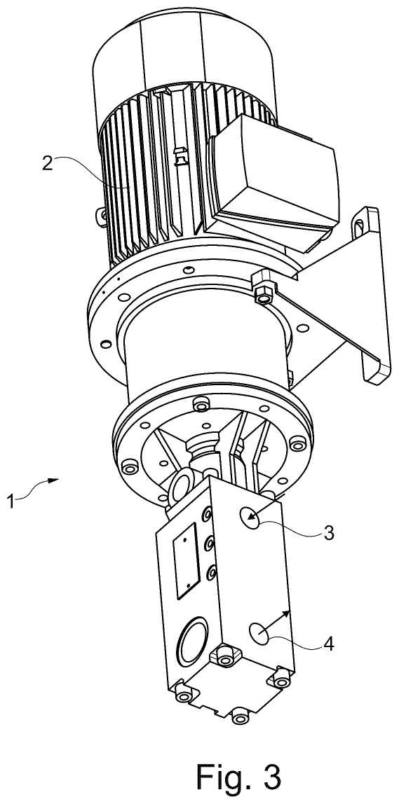

A special feature of this embodiment example is that the spatial arrangement of the material inlet 3 and the material outlet 4 of the spindle metering pump 1 is reversed compared to the prior art. The material inlet 3 is located at the drive end of the pump housing of the spindle metering pump 1, while the material outlet 4 is located at the distal end of the pump housing of the spindle metering pump 1, i.e. on the side facing away from the servo drive 2 (see FIG. 3). The material outlet 4 is therefore further away from the servo drive 2 than the material inlet 3. This reversal of the material inlet 3 of the material outlet 4 makes it possible for the applicator 9 to be flanged directly to the pump housing of the spindle metering pump 1. The swapping of the spatial arrangement of the material inlet 3 and the material outlet 4 compared to the prior art means that the application agent to be applied flows away from the servo drive 2 in the pump housing of the spindle metering pump 1 along the axis of rotation of the spindle metering pump 1, whereas in the prior art the application agent flows towards the servo drive 2 in the spindle metering pump 1.

On the one hand, the direct flange-mounting of the applicator 9 to the spindle metering pump 1 greatly shortens the flow path between the material outlet 4 of the spindle metering pump 1 on the one hand and the applicator 9 on the other, which enables more dynamic metering.

On the other hand, the direct flange-mounting of the applicator 9 to the spindle metering pump 1 also makes it possible to dispense with the hose line 8, as required in the prior art according to FIGS. 1A, 1B. This completely avoids the hose breathing that is disruptive in the prior art.

Furthermore, it can be seen from the drawings that the spindle metering pump 1 has a mounting flange 15 that can be detachably mounted on the mounting flange 10 of the application robot 11. A quick-release fastener is provided between the two mounting flanges 10, 15, which enables quick assembly and disassembly. It should be mentioned here that numerous other components are also mounted on the spindle metering pump 1, such as the heating module 7, the material pressure regulator 6 and the servo drive 2, so that the complete assembly with all these components can be mounted and removed quickly and easily. This is also an advantage over the prior art as shown in FIGS. 1A, 1B, where the applicator 9 and the spindle metering pump 1 have to be assembled and disassembled separately.

In addition, pressure sensors 16, 17 are provided on the spindle metering pump 1 in order to measure the pressure of the application agent upstream of the material pressure regulator 6 or downstream of the material pressure regulator 6.

Furthermore, a pressure sensor 18 is provided on the spindle metering pump 1, which measures the pressure of the application agent on the applicator 9.

The drawings also show a pneumatic proportional valve 19, which supplies the material pressure regulator 6 with a target value for the pump inlet pressure of the spindle metering pump 1 at the material inlet 3. The material pressure regulator 6 then regulates the pump inlet pressure at the material inlet 3 of the spindle metering pump 1 to the specified target value during operation. The proportional valve 19 can be controlled by a pump controller, which in this way specifies the target value.

FIG. 3 shows a perspective view of the spindle metering pump 1 as shown in FIGS. 2A and 2B, but with the other components disassembled. The material inlet 3 and the material outlet 4 of the spindle metering pump 1 are only shown schematically.

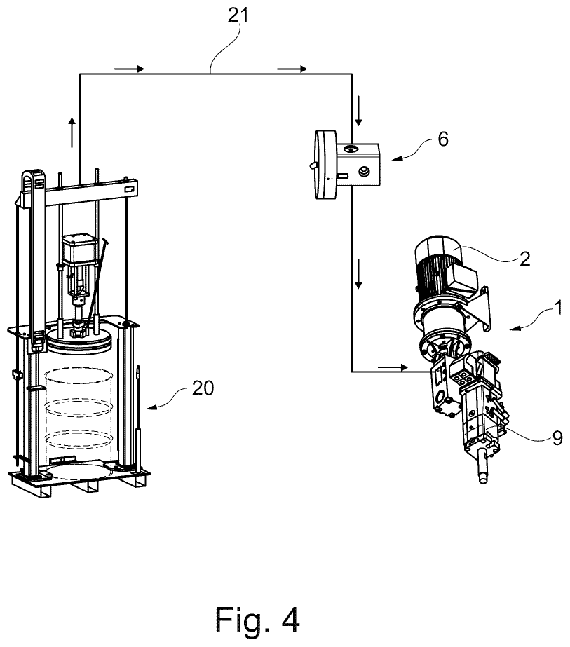

FIG. 4 shows a schematic representation of an application device according to the disclosure with the spindle metering pump 1 according to the disclosure and the material pressure regulator 6, so that reference is made to the above description in order to avoid repetition. In addition, the drawing shows a piston pump 20 that provides a delivery pressure of 350 bar. The piston pump 20 is connected to the material pressure regulator 6 via a pipe 21, whereby the material pressure regulator 6 then regulates the very high delivery pressure of the piston pump 20 down to the desired pump inlet pressure of the spindle metering pump 1. In some embodiments, the piston pump 20 is a compressed air-operated scoop piston pump, which is marketed by the applicant under the product name “EcoPump VPS™”.

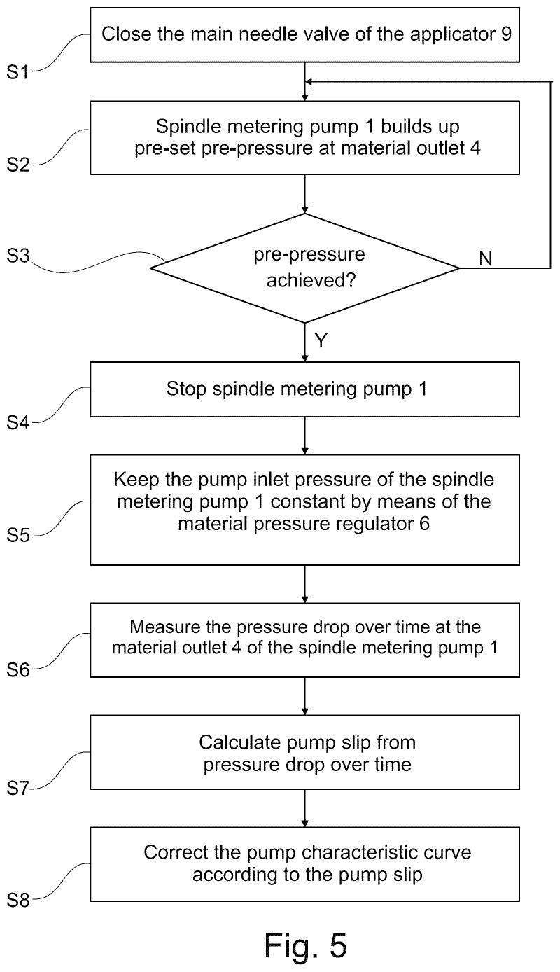

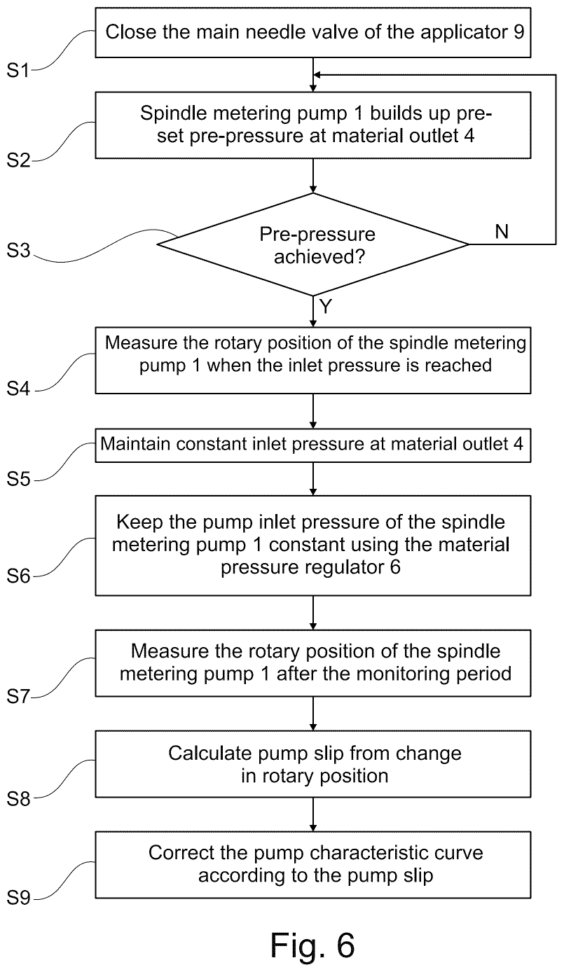

FIGS. 5 and 6 show two flow diagrams to illustrate how the pump slip of the spindle metering pump is determined. It should be mentioned here that it is a characteristic of metering devices by definition that the volume flow delivered is basically independent of the pressure ratios at the inlet and outlet of the metering device. However, this ideal behavior of a metering device cannot be fully achieved in practice, for example due to mechanical wear. The disruptive pump slip can therefore lead to metering errors during operation of the spindle metering pump 1. The disclosure therefore also makes it possible to determine the interfering pump slip and subsequently correct the pump slip. For this purpose, the disclosure offers two variants, which are shown in FIGS. 5 and 6.

In the variant of the disclosure according to FIG. 5, the main needle valve of the applicator 9 is first closed in a first step S1.

In a second step S2, the spindle metering pump 1 then builds up a pre-pressure at the material outlet 4 of the spindle metering pump 1.

In a step S3, the pressure sensor 18 continuously measures whether the desired inlet pressure is reached.

When the desired inlet pressure is reached at the material outlet 4 of the spindle metering pump 1, the spindle metering pump 1 is then stopped in a step S4.

The pump inlet pressure at the material inlet 3 of the spindle metering pump 1 is then kept constant by the material pressure regulator 6 in a step S5.

Subsequently, due to the unavoidable interfering pump slip, there is a pressure drop over time at the material outlet 4 of the spindle metering pump 1, whereby this pressure drop over time is continuously measured in a step S6.

In step S7, the pump slip is then calculated from the pressure drop over time.

In the next step S6, the pump characteristic curve can then be corrected according to the determined pump slip, whereby the corrected pump characteristic curve is then used to control the spindle metering pump.

FIG. 6 shows another flow diagram illustrating a second variant of the disclosure for determining the pump slip.

Here too, the main needle valve of the applicator 9 is closed in a first step S1.

In the next step S2, the spindle metering pump 1 then builds up a predetermined pre-pressure at the material outlet 4 of the spindle metering pump 1.

Step S3 then continuously checks whether the desired inlet pressure has been reached at the material outlet 4 of the spindle metering pump 1.

If this is the case, the rotational position of the spindle metering pump 1 is measured in step S4 when the inlet pressure is reached. This measurement of the rotary position can be carried out by a rotary encoder, for example. When using the servo drive 2, however, the rotary position of the spindle metering pump 1 is known anyway due to the control of the servo drive 2, so that a separate rotary encoder can be dispensed with.

In the next step S5, the inlet pressure at the material outlet 4 of the spindle metering pump 1 is then kept constant. Due to the unavoidable disruptive pump slip, this requires the spindle metering pump 1 to be rotated at least a little further.

In step S6, the pump inlet pressure at the material inlet 3 of the spindle metering pump 1 is then kept constant by the material pressure regulator 6.

After a monitoring period has elapsed, the rotational position of the spindle metering pump 1 is measured again in step S7.

In the next step S8, the pump slip is then derived from the change in the rotational position of the spindle metering pump 1 during the monitoring period.

The last step S9 then again provides for the pump characteristic curve to be corrected according to the determined pump slip, whereby the corrected pump characteristic curve can then be used to control the spindle metering pump 1.

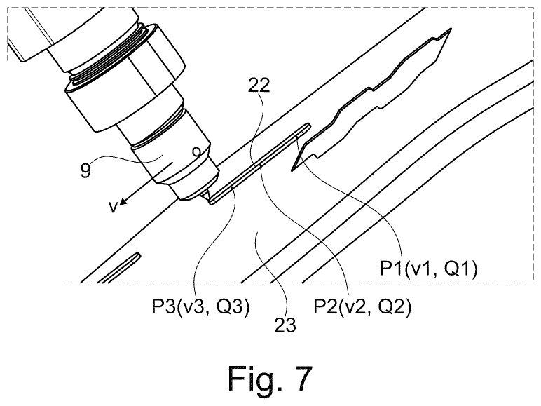

Finally, FIG. 7 shows a perspective view to illustrate the application of an adhesive bead 22 to a motor vehicle body component 23 by the applicator 9. By way of example, several points P1, P2, P3 are shown along the adhesive bead 22, in which the speed of movement v of the applicator 9 and the volume flow Q of the adhesive applied by the applicator 9 can have different values v1, v2, v3 or Q1, Q2, Q3. In the context of the disclosure, it is therefore possible for both the speed of movement v of the applicator 9 and the volumetric flow rate Q of the adhesive applied by the applicator 9 to be varied highly dynamically along the adhesive bead 22 (“brush”).

### Advantages of the Disclosed Technology

The main advantages of the disclosure are briefly summarized below:
In the spindle metering pump according to the disclosure, the applicator can be flange-mounted directly to the spindle metering pump due to the reversed spatial arrangement of the material inlet and material outlet.
The direct flange-mounting of the applicator to the spindle metering pump enables a short flow path between the spindle metering pump and the applicator, which allows highly dynamic metering.
The direct flange-mounting of the applicator to the spindle metering pump makes it possible to dispense with the previously used hose line between the spindle metering pump and the applicator, thus avoiding the annoying hose breathing.
The material pressure regulator upstream of the spindle metering pump enables smoothing of possible pressure pulsations from the material supply (e.g. piston pump). The spindle metering pump therefore receives a constant pump inlet pressure.
By controlling the material pressure regulator appropriately, an optimum pump inlet pressure can be selected for different brushes.
By regulating the pump inlet pressure, the pump slip can be reduced, which leads to an increase in metering accuracy, an extension of the service life of the spindle metering pump and reduced material shearing of the application agent.
Monitoring the pump slip enables a higher and constant metering accuracy over the entire service life and an extended service life of the spindle metering pump by compensating for any increase in pump slip during the service life.
The structural integration of the spindle metering pump and the applicator and other components enables easier assembly and disassembly on the application robot.

1-32. (canceled)

19. A spindle metering pump for metering an application agent, comprising:
a) a material inlet for receiving the application agent to be applied,
b) a material outlet for dispensing the application agent to be applied, and
c) a rotary drive for rotating the spindle metering pump,
d) wherein the material outlet on the spindle metering pump is arranged further away from the rotary drive than the material inlet.

20. The spindle metering pump according to claim 19, wherein
a) the material inlet on the spindle metering pump is arranged laterally with respect to the axis of rotation of the spindle metering pump, and
b) the material outlet on the spindle metering pump is arranged laterally with respect to the axis of rotation of the spindle metering pump.

21. The spindle metering pump according to claim 20, wherein the material inlet and the material outlet are arranged on the spindle metering pump on the same side surface of the spindle metering pump.

22. The spindle metering pump according to claim 20, wherein the material inlet and the material outlet are arranged on the spindle metering pump on opposite side surfaces of the spindle metering pump.

23. The spindle metering pump according to claim 20, wherein the material inlet and the material outlet are arranged on the spindle metering pump on adjacent side surfaces of the spindle metering pump.

24. The spindle metering pump according to claim 20, wherein
a) the rotary drive is arranged with its drive shaft coaxial to the spindle of the spindle metering pump, and
b) the application agent in the spindle metering pump flows along the axis of rotation of the spindle metering pump away from the rotary drive.

25. An application device, comprising:
a) a spindle metering pump according to claim 19, and
b) an applicator for applying the application agent to a component, the applicator being flange-mounted on the end of the spindle metering pump which faces away from the rotary drive.

26. The application device according to claim 25, wherein
a) the material outlet of the spindle metering pump is connected to the applicator by a flow path, and
b) the flow path between the material outlet of the spindle metering pump and the applicator is tubeless and pipeless.

27. The application device according to claim 25, wherein
a) the material outlet of the spindle metering pump is connected to the applicator by a flow path, and
b) flow path between the material outlet of the spindle metering pump and the applicator is shorter than 1 m, 50 cm, 20 cm, 10 cm or 5 cm.

28. The application device according to claim 25, wherein a material pressure regulator is connected upstream of the material inlet of the spindle metering pump, which regulates the pump inlet pressure of the application agent at the material inlet of the spindle metering pump.

29. The application device according to claim 28, wherein the material pressure regulator regulates the pump inlet pressure of the application agent at the material inlet of the spindle metering pump such that the pump slip of the spindle metering pump is minimal, the pump slip representing the deviation between the volume flow actually delivered by the spindle metering pump and the theoretical volume flow predetermined by a pump characteristic curve of the spindle metering pump as a function of speed.

30. The application device according to claim 28, wherein the material pressure regulator regulates the pump inlet pressure of the application agent at the material inlet of the spindle metering pump such that the wear of the spindle metering pump is minimal.

31. The application device according to claim 28, further comprising
a) a first pressure sensor for measuring the pump inlet pressure of the application agent at the material inlet of the spindle metering pump, wherein the first pressure sensor is connected to the material pressure regulator and supplies the measured pump inlet pressure as an actual value to the material pressure regulator, and
b) a second pressure sensor for measuring the pump outlet pressure of the application agent at the material outlet of the spindle metering pump, wherein the second pressure sensor is connected to the material pressure regulator and supplies the measured pump outlet pressure as an actual value to the material pressure regulator.

32. The application device according to claim 31, further comprising a third pressure sensor for measuring the pressure of the application agent at the inlet of the material pressure regulator, wherein the third pressure sensor is connected to the material pressure regulator and supplies the material pressure regulator with the measured pressure of the application agent at the inlet of the material pressure regulator as an actual value.

33. The application device according to claim 31, further comprising a rotary encoder for detecting the rotary position of the spindle metering pump.

34. The application device according to claim 28, wherein
a) the material pressure regulator has a target input at which the material pressure regulator receives a target value for the pump inlet pressure of the application agent at the material inlet of the spindle metering pump,
b) the target input of the material pressure regulator is supplied with the target value via a proportional valve.

35. The application device according to claim 34, wherein the proportional valve operates pneumatically.

36. The application device according to claim 28, wherein the application device has a piston pump which is arranged upstream of the material pressure regulator and conveys the application agent with a specific pump outlet pressure via the material pressure regulator to the spindle metering pump.

37. The application device according to claim 36, wherein the pump outlet pressure of the piston pump is greater than the pump inlet pressure of the spindle metering pump, wherein the material pressure regulator regulates the pump outlet pressure of the piston pump down to the pump inlet pressure of the spindle metering pump.

38. The application device according to claim 37, wherein the piston pump is connected to the material pressure regulator as follows:
a) via a rigid pipe,
b) via a flexible hose, or
c) via a combination of a rigid pipe and a flexible hose.

39. The application device according to claim 38, wherein the pipe between the piston pump and the material pressure regulator has a pipe length of at least 2 m, 4 m, 6 m, 8 m, 10 m or 12 m.

40. The application device according to claim 38, wherein the piston pump is a scoop piston pump operated by compressed air.

41. The application device according to claim 38, wherein the piston pump has a maximum delivery pressure of at least 10 bar, 50 bar, 100 bar, 200 bar or 350 bar.

42. The application device according to claim 25, wherein
a) the applicator does not contain a regulator, but only at least one main valve which selectively releases or blocks the material discharge through the applicator,
b) the main valve is a main needle valve.

43. The application device according to claim 25, wherein
a) the application device has a heater for heating the application agent, and
b) the application device has a mounting flange for detachable mounting of the application device on a robot flange of an application robot, the application device comprising the following components, which can be mounted together on the robot flange of the application robot by means of the mounting flange and are flange-mounted on the spindle metering pump:
b1) the spindle metering pump with the rotary drive,
b2) the applicator,
b3) the material pressure regulator,
b4) the proportional valve,
b5) the first pressure sensor and/or the second pressure sensor and/or the third pressure sensor, and/or
b6) the heater, and
c) the spindle metering pump is designed to deliver a volume flow of at least 5 cm³/s, 10 cm³/s, 20 cm³/s or 24 cm³/s, and
d) the spindle metering pump is designed for an operating range of the volume flow from 2cm³ /s to 24 cm³/s, and
e) the rotary drive of the spindle metering pump is an electromotive servo drive, so that the rotary position of the servo drive is known through the control of the servo drive.

44. An Application system, comprising:
a) two application devices according to claim 25 for conveying one component each of a two-component material, and
b) a mixer for mixing the two components of the two-component material.

45. An application robot with a plurality of robot arms and a robot flange, wherein the application device according to claim 25 is mounted on the robot flange.

46. An operating method for an application device according to claim 25, wherein a pump slip of the spindle metering pump is determined.

47. The method according to claim 46, further comprising one or more of the following steps for determining the pump slip of the spindle metering pump:
a) closing the main valve of the applicator,
b) building up a predetermined pre-pressure at the material outlet of the spindle metering pump by the spindle metering pump delivering the application agent against the closed main valve,
c) measuring the pump outlet pressure at the material outlet of the spindle metering pump by means of the second pressure sensor,
d) switching off the spindle metering pump when the pump outlet pressure at the material outlet of the spindle metering pump reaches the specified inlet pressure,
e) regulating the pump inlet pressure at the material inlet of the spindle metering pump to a constant target value by means of the material pressure regulator,
f) measuring the pressure drop over time at the material outlet of the spindle metering pump or at the applicator upstream of the main valve during a monitoring period after the spindle metering pump has been switched off by means of the second pressure sensor, and
g) evaluating the pressure drop over time during the monitoring period to determine the pump slip of the spindle metering pump.

48. The method according to claim 46, further comprising one or more of the following steps for determining the pump slip of the spindle metering pump:
a) closing the main valve of the applicator,
b) building up a predetermined pre-pressure at the material outlet of the spindle metering pump by the spindle metering pump delivering the application agent against the closed main valve,
c) measuring the pump outlet pressure at the material outlet of the spindle metering pump by means of the second pressure sensor,
d) detecting the rotational position of the spindle metering pump when the pump outlet pressure at the material outlet of the spindle metering pump reaches the predetermined inlet pressure,
e) regulating the pump inlet pressure of the spindle metering pump to a constant target value by means of the material pressure regulator,
f) regulating the pump outlet pressure at the material outlet of the spindle metering pump to the specified inlet pressure by controlling the rotary drive of the spindle metering pump,
g) measuring the temporal change in the rotational position of the spindle metering pump during a monitoring period after the predetermined inlet pressure has been reached, the monitoring period comprising several minutes, and
h) evaluating the change in the rotational position of the spindle metering pump over time during the monitoring period to determine the pump slip of the spindle metering pump.

49. The method according to claim 47, wherein
a) a correction is made depending on the determined pump slip in order to avoid metering errors,
b) the correction provides for a new pump characteristic curve to be measured which reflects the relationship between the pump speed of the spindle metering pump and the delivered volume flow.

50. The method according to claim 46, wherein
a) an elongated bead of the application agent is applied to a component by the applicator by guiding the applicator along the bead over the component at a specific speed of movement, the applicator applying the application agent at a specific volumetric flow rate,
b) the volume flow of the application agent is dynamically varied during the movement of the applicator along the bead, and
c) the speed of movement of the applicator is varied dynamically during the movement of the applicator along the bead.
